(19) United States
(12) Patent Application Publication
(10) Pub. No.: US 2003/0174122 A1
(43) Pub. Date: Sep. 18, 2003

(54) Adaptation of a human-machine interface as a function of a psychological profile and a current state of being of a user

(75) Inventors: Clemens Dinges, Obermichelbach (DE); Michael Schlereth, Wilhermsdorf (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/355,276

(22) Filed: Jan. 31, 2003

(30) Foreign Application Priority Data
Mar. 12, 2002 (DE) 10210799.8

(51) Int. Cl. G09G 5/00

(52) U.S. Cl. 345/156

(57) ABSTRACT

A system and a method of adapting a human-machine interface (2) to the individual requirements of a user (1). The system contains a first acquisition component (10) for acquiring a psychological profile of at least one user (1), a second acquisition component (20) for acquiring a current state of being of the respective user (1), and an adaptation component (20) for dynamically adapting the human-machine interface (2) as a function of the acquired psychological profile (18) and the acquired current state of being (28) of the respective user (1).

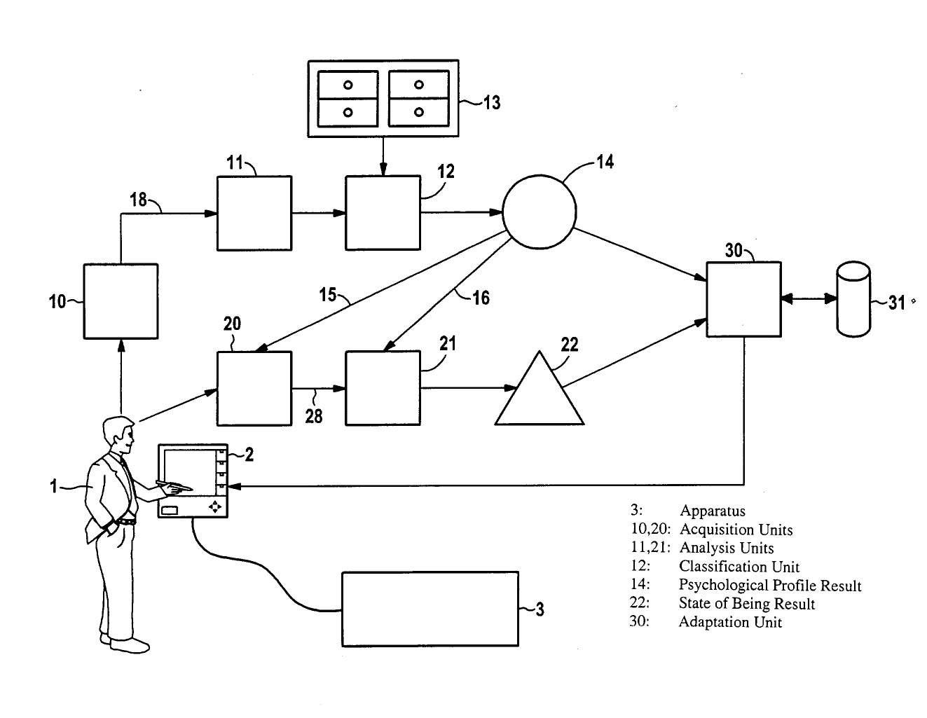

The following disclosure is based on German Patent Application No. 10210799.8, filed on Mar. 12, 2002, which is incorporated into this application by reference.

### FIELD OF AND BACKGROUND OF THE INVENTION

The present invention relates to a system and a method of adapting a human-machine interface, particularly an interface between a user and an apparatus, a facility or a machine.

The planning and design of human-machine interfaces, of operator control and monitoring systems, for example, is typically derived from abstract operating scenarios and the abstract roles assumed by the user in these scenarios. Adaptations of the human-machine interface by the user himself are either not possible or are only possible to a limited extent, for example, in the form of changes of the position or the size of output windows.

### OBJECTS OF THE INVENTION

One object of the present invention, therefore, is to provide a human-machine interface which is tailored to the individual requirements of a user.

### SUMMARY OF THE INVENTION

According to one formulation, this and other objects are achieved by a system for adaptation of a human-machine interface,

having first acquisition means for acquiring a psychological profile of at least one user,

having second acquisition means for acquiring a current state of being of the respective user, and

having adaptation means for dynamic adaptation of the human-machine interface as a function of the acquired psychological profile and the acquired current state of being of the respective user.

The invention, according to another formulation, is directed to a method of adapting a human-machine interface, in which

a psychological profile of a user is acquired, e.g. using first acquisition Means,

a current state of being of the respective user is acquired, e.g. using second acquisition means, and

the human-machine interface is dynamically adapted to the respective user as a function of the acquired psychological profile and the acquired current state of being of the respective user.

The system and/or the method according to the present invention allows the human-machine interface to be passively adapted to the psychological profile and the current state of being of a user and thus causes the system to actively adapt to the user. The adaptation means of the human-machine interface analyze the acquired psychological profile and the acquired current state of being and, on the basis of the results of this analysis, dynamically adapt the human-machine interface in such a way that the respective user is individually supported and therefore the state of being of the user is not only taken into consideration, but also positively influenced as much as possible. Through feedback using repeated or continuous acquisition of the current state of being of the user, the system automatically monitors and/or regulates the success of the dynamic adaptation of the human-machine interface. By positively influencing the individual state of being of the user, his performance is increased, so that he may achieve the object which he is working on using the human-machine interface faster and better. The concept of “human-machine interface” is to be understood here in the original sense of the word, i.e., a bidirectional interface to a technical device which affects any or all senses, feelings, and preferably also the intellect of the user. The adaptation means are used for adaptation of the human-machine interface in at least one of these forms.

In contrast to the system according to the present invention, in previously known systems for adapting a human-machine interface, the individuality and particularly the respective current state of being of different users in the same role in the same operating scenarios are not taken into consideration. All users are treated the same and each individual user is always treated in the same way. In contrast to the system and method according to the present invention, a significant increase of the individual feeling of happiness and therefore the performance of the user is not sought and therefore is also typically not achieved. The previously unusable potential for increasing the productivity and for improving the quality of results by taking the individual psychological profile and the current, individual state of being of the respective user into consideration is developed for the first time by the systems and method disclosed here.

According to an advantageous embodiment of the present invention, the human-machine interface has an operator control and monitoring system, the adaptation means being provided for selecting operating options and/or for selecting information to be provided by the interface. The adaptation means therefore dynamically and automatically adapt the available operating parameters and the information to be provided by the interface in the operator control and monitoring system to the previously acquired individual psychological profile and the repeatedly or continuously acquired current state of being of the respective user. The operator control and monitoring system is actively adapted to the user during operation and may thus actively influence him.

In previously known operator control and/or monitoring systems, adaptations by the user during operation are only possible in a very restricted way. Adjustments may typically only be performed during the planning and design phase by a planner and are therefore static during the operational management phase. Adaptations of an operating system by the operating system itself are found in known operating systems in the office world, but less so in automation technology. These adaptations, however, are based on rigid rules, whose respective application is based on statistical analyses of operating processes. An example of this is the automatic start of a help assistant when a predetermined time has passed between two interactions or the automatic assignment of a direct selector key to a function which is nested in a call tree, but is frequently called. However, these adaptations, which are performed by previously known operating systems themselves, do not consider the emotions of the respective user, since the adaptations are only support mechanisms of the operating system, which is identical for all users. The operating system is not to know and does not seek to know anything about the state of being of the respective user and does not seek to influence it.

For simple planning and design of the human-machine interface, it is suggested that evaluation means evaluate various components of the human-machine interface based on the dependence of the respective components on the psychological profile of the user and the effect of the respective components on the current state of being of the respective user. The evaluation produces the relationship between the form of a component of the human-machine interface and the psychological profile of a user and the effect on his current state of being (e.g., without effect, amplification of a desired mood, attenuation of an undesired mood). The components are typically evaluated in the planning and design phase of the system or even in the course of development of the system. The evaluation may be stored in the system in the form of default values for operating categories and assigned states of being and/or mood settings. The evaluation may be obtained empirically with the aid of the evaluation means. Results of the evaluation may be, for example, defined specified goals, character-specific reward/punishment scenarios, and mood-specific and character-specific rules for information selection. The evaluation represents a directly marketable resource (as an evaluation for categories) and/or an indirectly marketable resource (as a unique feature of the system).

The system according to the present invention may support different users especially effectively if storage means are provided for storing the assignment of the acquired psychological profile of a user to the respective user. Such storage means, in the form of a database, for example, may contain different user accounts, which are automatically loaded and activated when a user logs into the system. Therefore, the relatively time-consuming acquisition of the psychological profile is necessary only one time, typically during the first login and/or during opening of a user account.

Since the psychological profile of the respective user is always available to the system after the single acquisition, analysis means may advantageously be provided to analyze the respective acquired current state of being as a function of the psychological profile of the respective user. Depending on the psychological profile and/or user, the state of being acquired in this way may be evaluated differently and the system may react differently to the current state of being.

In order to reduce the potential number of different psychological profiles and to systematize and therefore simplify their evaluation, it is suggested that classification means be provided for classifying the acquired psychological profile. The acquired psychological profile is categorized and is then available for further processing in the system.

According to a further advantageous embodiment of the present invention, not only the analysis, but also the acquisition of the current state of being of the user, i.e., the current psychological and/or physiological state of the user, by the second acquisition means, is a function of the acquired psychological profile. Depending on the psychological profile of the respective user, different acquisition types and acquisition times may be selected on this basis. The second acquisition means may have, for example, first measurement means for acquiring information about an operating behavior of the user and/or second measurement means for acquiring biometric data from the user.

The system described may be used particularly advantageously for facility operation and facility engineering if the human-machine interface which influences the user forms an interface between the user and a facility. The concept of facility is to be understood here as a single machine or multiple machines, an automation facility, a manufacturing facility, an industrial process, and the like.

Previously known systems for facility operation and facility engineering are derived from abstract operating scenarios and the supposed roles of the user in these scenarios. All users are treated the same during execution of a specific role. There is no aim to achieve the closest possible approximation to the respective individual emotional profile of the user.

### BRIEF DESCRIPTION OF THE DRAWINGS

In the following, the present invention is described in more detail and explained on the basis of the exemplary embodiment illustrated in the FIGURE.

### DETAILED DESCRIPTION OF THE PREFERRED EMBODIMENTS

The FIGURE shows a system for adapting a human-machine interface 2. The human-machine interface 2 forms the interface between a user 1 and an apparatus, a facility or a machine 3, and is implemented in the exemplary embodiment as an operator control and monitoring system. The user 1 operates and monitors the machine 3 using the human-machine interface 2. A first acquisition unit 10 acquires an individual psychological profile 18 of the user 1, which is analyzed by a first analysis unit 11. The acquired and analyzed psychological profile is classified using a classification unit 12, i.e., placed in different classes 13. The result of the psychological profile determination is identified by the reference number 14.

A current state of being of the user 1 is acquired using a second acquisition unit 20. The current state of being 28 acquired is analyzed using a second analysis unit 21. Both the acquisition by the second acquisition unit 20 and the analysis by the analysis unit 21 may be performed as a function of the results 14 of the preceding psychological profile determination. This dependence is identified using the reference numbers 15 and 16, respectively. The result 22 of the state of being determination and the result 14 of the psychological profile determination are input variables to the adaptation unit 30. The adaptation unit 30 has access to storage unit 31 and influences the human-machine interface 2.

In the following, the ideas upon which the present invention is based are explained with reference to the exemplary embodiment. The present invention builds on the observation that happy people are the most productive. Through the user-specific (i.e., performed as a function of the psychological profile and the current state of being of a user 1) adaptation of a human-machine interface 2 and therefore through the active influencing of the user 1, his individual feelings of happiness, and therefore his work productivity, are increased.

The acquisition of the psychological profile of the user 1 is typically performed once using the first acquisition unit 10. The individual psychological profile of a user 1 considers, for example, his basic emotional pattern, values, basic views, etc. The acquired psychological profile 18 is categorized using the classification unit 12 and assigned to the user account of the respective user 1. The categorization may be performed according to any or several of a variety of different approaches and methods. Such approaches for categorizing and determining psychological profiles have been developed, for example, by Gunter Dueck, David Keirsey, Myers-Brigg, or multidimensionally in the Freiburg Personality Inventory. They are typically based on Carl Gustav Jung's theory of “psychological types.” Carl Gustav Jung, a student of Sigmund Freud, discovered, on the basis of his practical work as a psychoanalyst with patients, three pairs of dispositions, i.e. three sets of temperaments, which are present in differing degrees in different people, (thinking—feeling; sensation—intuition; extraversion—introversion). Depending on the approach, personality types may thus be divided into different classes 13 and/or subclasses. The categorization is used as a “coarse adjustment,” for the selection of the reward profile during operation, for example. The “fine adjustment” is performed through the acquisition and evaluation of the current state of being of the user 1.

The system may perform the acquisition of the psychological profile during the setup of the user account of the respective user 1. There is preferably no self-evaluation by the user 1. Also preferably, the psychological profile is adopted only to the extent necessary for the respective application, for example, in the present case, automation. In the following, examples of the first acquisition unit 10, the first analysis unit 11, and the classification unit 12 are cited. The boundaries between these components are partially fluid, for example, the acquisition unit, the analysis unit, and the classification unit may be combined into one tool. The acquisition may be performed in that the user 1 plays an electronic game. By evaluating the user behavior in the game and/or the game result and/or the type of game selected (e.g., first person shooter, simulation game), the psychological profile of the respective user 1 may be determined. In a second example, the user 1 answers questions connected to opinions, or expresses positive/negative feelings upon observing images displayed or upon hearing music samples.

Finally, the acquisition and/or determination of the psychological profile may be performed by answering a questionnaire tailored to one of the approaches cited above (Keirsey, Freiburg Personality Inventory, etc.) and by automatically acquiring and analyzing the answers of the user 1. Such a psychological profile acquisition may be performed through interactive acquisition of the answers of the user 1 using Web technologies, for example, via the Internet or via an intranet.

The acquisition of the current state of being of the user 1 may be performed by acquiring and analyzing the general operating behavior of the user, for example, comparing the frequency of repeated keystrokes in specific operating situations, e.g. “normally” versus “today” (“nervous hammering on the keyboard.” . . . ), comparison of the type of mouse movement, comparison of the time intervals between specific interactions (menu calls . . . ), and the like. Additional acquisition methods are based, e.g., on the analysis of biometric measurements, for example, of speech signals (e.g., analysis of the glottal flow), of arm movements (e.g., “electronic DJ and armband” or “virtual keyboard,” in which there are two armbands on the arms so that one may type in the air/on any table), of the conductivity of the skin (e.g., picked up on the mouse, lie detector technology), of the body temperature, or monitoring of the face, mimicry, head movements, etc. The acquisition methods cited above may be combined to improve the results. In contrast to the acquisition of the psychological profile, the time used to acquire the current state of being may not be great, since the acquisition must occur in the operational management phase, e.g., in the login phase and/or even later (for dynamic adaptation of the operator control and monitoring system, if, for example, the mood setting of the user 1 has improved through the measures described below).

The procedure during the acquisition and the analysis of the results of the acquisition of the current state of being is always performed as a function of the basic emotional pattern, and of the psychological profile of the respective user. A result 22 of the state of being determination may be, for example: “operator very tired and unfocused.” In addition to the general daily condition and the mood setting, the special reaction of the user 1 to actions of the operator control and monitoring system may also characterize the state of being, for example, “appears not to want to know any details today,” “appears not to want to refill the oil before lunch.” The result 22 of the state of being determination is used by the adaptation unit 30, together with the result 14 of the psychological profile determination, to determine a system reaction. The adaptation unit 30 is, for example, algorithms which are executable on a computer.

The adaptation unit 30 influences the recognized state of being of the user 1 (active adaptation of the user 1) in a targeted way, tailored to the individual psychological profile, by adapting the human-machine interface 2. The attempt is made to “adapt” the user 1 to the system and/or the task, in that the system modifies itself in view of the individual user 1. In order to accomplish this, the respective psychological profile is taken into consideration. One user, who has a first psychological profile, prefers to gain an understanding of the principles, desires open solution finding, and structures and plans his work himself. In contrast, a second user, having another personality form, and a second psychological profile, wants to work according to rules and wants to know what is waiting for him on the next day. Finally, a third user, who in turn has a different third psychological profile, prefers to work unplanned and in relation to the situation. The system suggested here uses this information and correspondingly adapts the human-machine interface 2. The system provides different information to the user as a function of the user's respective psychological profile form, for example, a workflow-oriented manual or a principle-oriented manual. The selection of the type and method of providing information (e.g., visual, acoustic, haptic), the format for the information, etc., are also to be understood under the concept of “adaptation of the human-machine interface.” In the system and method suggested here, in contrast to office applications, there are significantly more possibilities for increasing the user satisfaction and therefore the productivity of the user. The adaptation of the human-machine interface to achieve satisfaction and happiness in work may extend far beyond simple adaptation of a user interface: further embodiments of adaptation of the human-machine interface are individualized reward/punishment methods and/or methods of selecting the information provided to the user (information selection), each as a function of the psychological profile and/or the current state of being of the respective user.

The following discussion provides exemplary embodiments of adaptations of the human-machine interface 2, which may be used individually or in combination.

In general, the format in which the information is rendered and presented, e.g., on a monitor, may be influenced by the system: for example, through color schemes (colors used for background, window frames, script color), through layout/design (number/position of the windows, skins), through quantity of information, fonts (type of script, size of script), and by taking design paradigms from the entertainment industry (e.g., from first person shooters, movies). Operating trees (there are multiple types!) having greatly differing forms of interaction may be used: e.g., assignment of key-operated functions, assignment of mouse-operated functions, functions may only be triggered by “convincing” the operating system, functions may only be triggered by “screaming” (used for reducing tension and aggression), depth/width of the operating tree, grouping of the functions, liberality of the function selection, speed of the operating system (hectic, leisurely . . . ). The system selects different sound schemes for the display of events arising, background music (e.g., airport music, “drum and bass”), background noises (e.g., splashing water), odor schemes, reward schemes (e.g., “top 10,” top scorer, point score, overlaying a video stream (TV, movie, etc.)). The extent of the help offered is adapted to the requirements of the user 1 (background information, “recipes,” “cheats and tricks,” guided tour, etc.). Finally, the type and extent of the information not necessary for operating/engineering the facility, such as news tickers, mini-games (like Tetris), and overlaying a webcam, may be used to influence the current state of being of the user 1 (e.g., in the framework of reward schemes). In order to avoid acclimatization effects, which greatly weaken the influencing strength of the respective adaptation unit, the system is designed in such a way that embodiments of an adaptation unit which have the same effect may subsequently be introduced seamlessly into the system and/or replaced in the system (e.g., new help systems, new incentive methods, new background music, etc.).

Methods of acquiring the psychological profile of a test subject, per se, are known, for example, from differential psychology. In contrast, the connection to a human-machine interface as described here and the conception of the system described here were not previously. Systems for acquiring the current state of a person are also known per se. However, these systems do not include classification of the individual psychological profile and, derived therefrom, the individual system reaction and/or influencing of the user., as described here For example, there is the so-called Smartcom system, which detects from mimicry that the operator is unsure/unsatisfied. In the Smartcom system, however, the operating interface is adapted in the same way for all users. The system suggested herein, in contrast, provides a functionality, for instance, in which a given user having a personality according to a first psychological profile (see above), receives a repeated explanation of the principal of the system, while a given user having a second psychological profile receives a picture-in-picture overlay showing a formula with the necessary operational steps.

In summary, the present invention therefore relates to a method of adapting a human-machine interface 2 to the individual requirements of a user 1. The system contains a first acquisition unit 10 for acquiring a psychological profile of at least one user 1, a second acquisition unit 20 for acquiring a current state of being of the respective user 1, and an adaptation unit 30 for dynamic adaptation of the human-machine interface 2 as a function of the acquired psychological profile 18 and the acquired current state of being 28 of the respective user 1.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A system for adapting a human-machine interface, comprising:
first acquisition means for acquiring a psychological profile of at least one user;
second acquisition means for acquiring a current state of being of the user; and
adaptation means for dynamically adapting the human-machine interface as a function of the acquired psychological profile and the acquired current state of being of the user.

2. The system according to claim 1, further comprising:
an operator control and monitoring system in the human-machine interface;
wherein the adaptation means selects operating options and selects information to be provided to the user based on the acquired psychological profile and the acquired current state of being.

3. The system according to claim 1, further comprising:
evaluation means for planning and design of the human-machine interface;
wherein the evaluation means evaluates at least one component of the human-machine interface in regard to dependence of the component on the psychological profile of the user and effect of the component on the current state of being of the user.

4. The system according to claim 1, further comprising:
storage means for storing an assignment of the acquired psychological profile of the user to the user.

5. The system according to claim 1, further comprising:
analysis means for analyzing the acquired current state of being of the user as a function of the acquired psychological profile of the user.

6. The system according to claim 1, further comprising:
classification means for classifying the acquired psychological profile.

7. The system according to claim 1, wherein:
the second acquisition means acquire the current state of being of the user as a function of the acquired psychological profile.

8. The system according to claim 1, wherein:
the second acquisition means comprises at least one of first measurement means for acquiring an operating behavior of the user and second measurement means for acquiring biometric data of the user.

9. The system according to claim 1, wherein:
the human-machine interface forms an interface between the user and a facility.

10. A method of adapting a human-machine interface, comprising:
acquiring a psychological profile of a user,
acquiring a current state of being of the user; and
dynamically adapting the human-machine interface as a function of the acquired psychological profile and the acquired current state of being of the user.

11. The method according to claim 10, wherein:
the dynamic adaptation comprises selecting at least one of operating options and user information content for the human-machine interface based on the acquired psychological profile and the current state of being.

12. The method according to claim 10, further comprising:
planning and designing the human-machine interface by evaluating at least one component of the human-machine interface in regard to a dependence of the component on the psychological profile of the user and an effect of the component on the current state of being of the user.

13. The method according to claim 10, further comprising:
assigning the acquired psychological profile of the user to the user; and
storing the assignment.

14. The method according to claim 10, further comprising:
analyzing the acquired current state of being of the user as a function of the acquired psychological profile of the user.

15. The method according to claim 10, further comprising:
classifying the acquired psychological profile.

16. The method according to claim 10, wherein:
the current state of being of the user is acquired as a function of the acquired psychological profile.

17. The method according to claim 10, wherein:
the current state of being of the user is acquired by acquiring an operating behavior of the user.

18. The method according to claim 10, wherein:
the current state of being of the user is acquired by acquiring biometric data of the user.

19. The method according to claim 17, wherein:
the current state of being of the user is acquired additionally by acquiring biometric data of the user.

20. The method according to claim 10, further comprising:
operating a facility with the adapted human-machine interface.

21. A system, comprising:
a first data unit configured to process predetermined user profile information for a given user;
a second data input for at least one temperament parameter for the given user that varies over time;
a second data unit configured to process the user temperament parameter; and
an adaptation unit configured to output control signals in accordance with the processed profile information and the processed temperament parameter.

22. The system according to claim 21, further comprising:
a user interface configured to receive and process the control signals.

23. The system according to claim 21, wherein the second data input comprises a sensor deriving the temperament parameter from a signal received from the given user.
